(19) United States
(12) Patent Application Publication
(10) Pub. No.: US 2016/0155205 A1
(43) Pub. Date: Jun. 2, 2016

(54) SPORTS THEME BASED PROPERTY DEVELOPMENT

(71) Applicant: B. SATYA VENKATA SRINIVAS, Hyderabad (IN)

(72) Inventor: B. SATYA VENKATA SRINIVAS, Hyderabad (IN)

(21) Appl. No.: 14/904,692

(22) PCT Filed: May 25, 2014
(86) PCT No.: PCT/IB2014/061700

§ 371 Date: Jan. 12, 2016

(30) Foreign Application Priority Data
Jul. 12, 2013 (IN) 3113/CHE/2013

(51) Int. Cl. G06Q 50/08; G06Q 10/10

(52) U.S. Cl. CPC G06Q 50/08; G06Q 10/10

(57) ABSTRACT

This invention relates to a sport or game theme based layout and has for its object to “live out the sport,”™ comprising of a plurality of buildings which are constructed to replicate or resemble various equipments and players with the field positions of the sport, referees, spectators related to the lifecycle of a specific sport or a combination of sports. A cricket, soccer, baseball, American football, chess layouts are disclosed by way of examples. The buildings could be used for any purpose and is not limited to educational, health care, hospitality, commercial, recreational or residential to relax, enjoy and cohabit with the sport to live out the dream life.

### FIELD OF INVENTION

The present invention relates to architectural layouts to build an educational or commercial or residential or any other purpose usage buildings based on a sports theme layout with a desired objective to provide individuals to co-habit and “live out the sport”™.

### BACKGROUND OF THE INVENTION

Historically sports have been a major part of human life in order to provide not only entertainment but also a way to stay healthy by continuous physical movement, mental fitness on the personal front and a way to connect states, nations, continents internationally and used for integration of people all around the world. Hence sports & games are an important element of human evolution. The basic thought of “Live out the Sport” has been conceptualized with the fact that what if the sport becomes part of everyday life in thought, deed and act than playing or watching the sport at a specific point in time.

Sporting activity brings fans and spectators together collectively for the enjoyment of the sports team, the sports players and the camaraderie of sharing event. Sports have become an incredibly important factor for entertainments in many countries and the tremendous growth in revenues is primed by televised broadcasting of games. Sports coupled with a variety of television services devoted to sports content made sports bars a hot trend beginning in the 1980. Also team conquests, through professional leagues, have become major business activities, both in the United States and in certain foreign countries, most recent success of Indian Premier League (IPL) in India. The addition of viewable sports content to a bar dramatically shift sales toward food purchases and this trend have more recently evolved into sports restaurants. A first substantial problem with conventional sports bars and sports restaurants may be that the architectural elements of the restaurant lack a theme. The US20070000185 patent provided a building the interior of which is configured as a central floor area surrounded by a plurality of tiers each of the plurality of tiers providing a seating area for restaurant patrons, along with a service pattern to provide restaurant services to the restaurant patrons in the seating areas. But this patent provides an entertainment and refreshing zone with sports theme which is short lived.

A House or work place is a basic place for people to live and work and is also an important symbol of the development and the quality of life of the people. Different houses and work places can give people different feelings of life, and are closely linked with people's health. For the characteristics of traditional architecture, high raised buildings with maximum usable spaces are designed to meet the desired requirements of urban lifestyles and pressures. U.S. Pat. No. 5,694,725 depicts layouts for multi-story buildings with multiple apartment units and providing two pathways between each third story apartment entrance and the ground by way of the stairways by which the building configuration maximizes usable space.

A substantial problem with these traditional architectural layouts may be the lack of a theme and while a variety of layouts and building structures have been disclosed for example by EP2011931 (Three-dimensional tube building structure), EP2557253 (Building design method), WO2008127198 (Multi-storey building design), U.S. Pat. No. 6,748,704 (Factory layout), US20120227337 (Building structure system which accords with human body architecture), U.S. Pat. No. 4,274,233 (Building layout for restaurant and artist work/exhibit area), U.S. Pat. No. 5,603,189 (Combined dwelling, marine habitat, and educational building complex), WO1997011467 (Method for building a nuclear power plant and layout thereof). However, none of these structures and layouts have a theme and keep the interest and dreams of the residents or the users of the building in mind to provide both residential and commercial amenities along with the objective of living a dream life.

As watching a sport or participating in a sport can be a helpful way of reducing stress levels and increase the feelings of physical and mental well-being, the present invention breaks the traditional architectural patterns, wherein a business area and/or a residential areas or layouts are accorded with sports theme layout to provide a platform for residents or visitors to live out the sport and completely submerge in a world of sport which will promote the communication, the harmony and the life quality of the users of the layout. It is possible to market such an experience to a prospective resident or guest as an opportunity to actually live or vacation inside their favourite sport residence. The consumer's love of sport is realised and fulfilled by this complete and fascinating development.

These and other objectives, features, and advantages of the present invention will become apparent from the following detailed description, the accompanying drawings, and the appended claims.

### SUMMARY OF THE INVENTION

The present invention provides an architectural layout to build a sport theme based residential, educational or commercial building based on a sports theme layout.

The invention is concerned particularly, although not exclusively, with a method of planning and design that generates a sports them layout, types of occupiable space and the form and distribution of the spaces between the plurality of buildings.

### BRIEF DESCRIPTION OF THE DRAWING:

FIG. 1: Top view of the sports based layout plan; 1(a) & 1(b) depicting the master plan layout as obtained by different area and shapes of the land available.

FIG. 2: Top view of the residential and financial zones in the sports based layout; 2(a) & 2(b) depicting the residential and financial zones in different layouts obtained by different area and shapes of the land available.

FIG. 3: Top view of the healthcare and polyclinics zones in the sports based layout; 3(a) & 3(b) depicting the healthcare and polyclinics zones in different layouts obtained by different area and shapes of the land available.

FIG. 4: Top view of the office and commercial zones in the sports based layout; 4(a) & 4(b) depicting the office and commercial zones in different layouts obtained by different area and shapes of the land available.

FIG. 5: Top view of the Special Economic Zone (SEZ) and Hospitality and or civic zones in the sports based layout; 5(a) & 5(b) depicting the SEZ and Hospitality and or civic zones in different layouts obtained by different area and shapes of the land available

FIG. 6: Top view of cricket based layout master plan showing the central game zone of building based on cricket game theme based and the layout comprising of different zones for various uses.

FIG. 7: 3-D view of cricket based layout master plan

FIG. 8: 3-D view of the buildings in the central game zone of the layout based on a cricket theme

FIG. 9: Side view of the buildings of a cricket theme based layout plan

FIG. 10: Top view of the soccer game theme based layout plan showing the central game zone of building based on soccer game theme based and the layout comprising of different zones for various uses.

FIG. 11: Top view of the baseball based theme layout plan showing the central game zone of building based on baseball game theme based and the layout comprising of different zones for various uses.

FIG. 12: Top view of the American football theme based layout plan showing the central game zone of building based on American football theme based and the layout comprising of different zones for various uses.

FIG. 13: Top view of the volley ball theme based layout plan showing the central game zone of building based on volley ball game theme based and the layout comprising of different zones for various uses.

FIG. 14: Top view of the chess game theme based layout plan showing the central game zone of building based on chess game theme based and the layout comprising of different zones for various uses.

### DETAILED DESCRIPTION OF THE PREFERRED EMBODIMENTS

The present invention recognizes the high level of market of sports used for the fanciful homes and businesses and it exploits this marketing opportunity in the form of products and services in the field of property development. In the description which follows, like elements are marked throughout the specification and the drawings with the same reference numerals, respectively. The drawing figures are not necessarily to scale and certain features of building particular the plurality of zones are shown in generalized form in the interest of clarity and conciseness. The embodiments that are described below include the development of individual homes, timeshare communities and complete urban areas that recreate the fantasy created by many remarkable events from the best loved sports of the world.

The present invention begins with a commitment to be a new kind of layout with a concept “Don't just watch, “Live out the Sport”, thereby allowing an individual to live out a sport or a hobby by living and or working in a sports theme layout comprising an array of occupiable spaces of predetermined shape, at least one access way communicating with each occupiable space. The occupiable spaces are a plurality of buildings that are inspired by a sport and are fabricated to resemble various equipments and individuals related to the lifecycle of a sport for example, a cricket, soccer, baseball, American football, chess, hockey, volley ball, tennis to name a few.

The sports theme based layout comprises of a stadium based area comprising of a plurality of zones such as residential 1, financial 2, healthcare 3, polyclinics 4, offices 5, bazaar 6, SEZ 7, Hospitality/Civic 8; and buildings for various amenities in the layout and a central game zone area. The central game zone area comprises of a plurality of buildings depicts the sport and consists of buildings which resemble various equipments and individuals related to the lifecycle of a sport for example, a cricket, soccer, baseball, American football, chess, hockey, volley ball, tennis to name a few. Obviously other types of sports themes may be used and the central game zone can vary and be adapted to the region in which the layout is constructed, to allow for local sports that are more popular than those specifically presented in the drawings and the description is not intended to limit the layout to these themes. Instead, the use of sport or game terminology is intended to be a description of a species of play within the generic concepts of the broad invention. Hence, the layout can represent any sport or sports by merely altering the art work of the plurality of buildings into the shape of a particular sport layout.

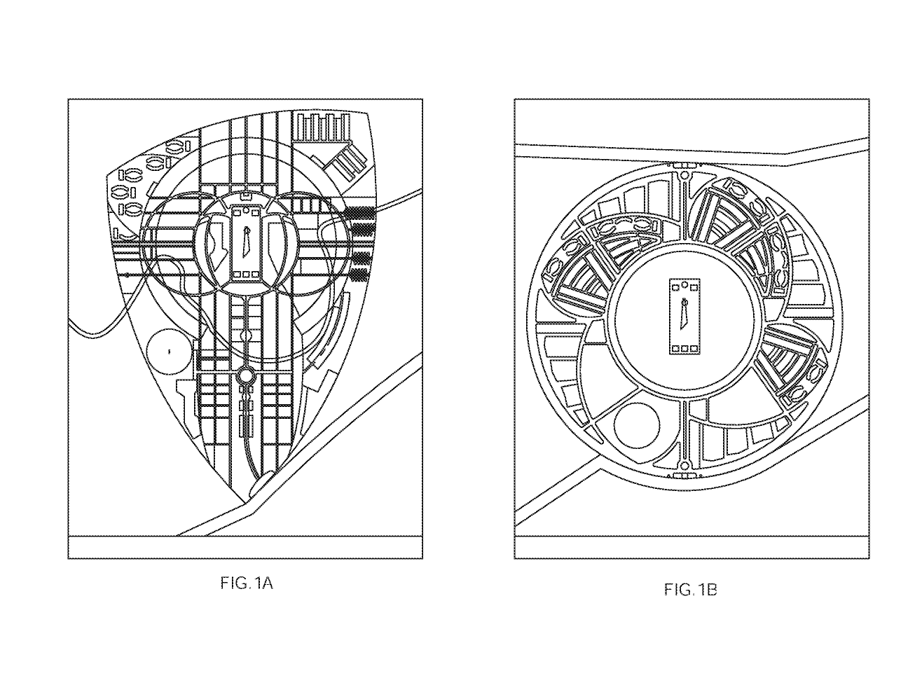

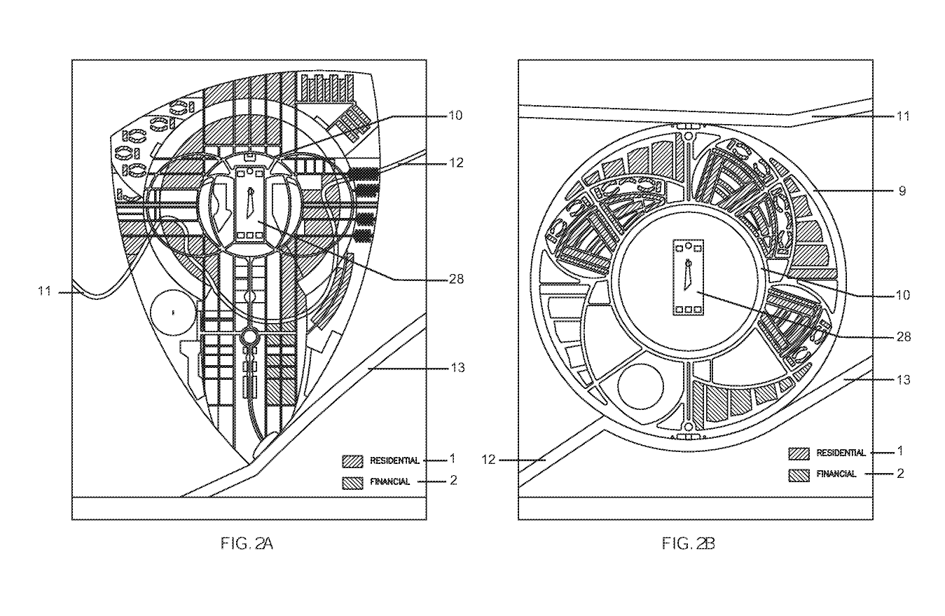

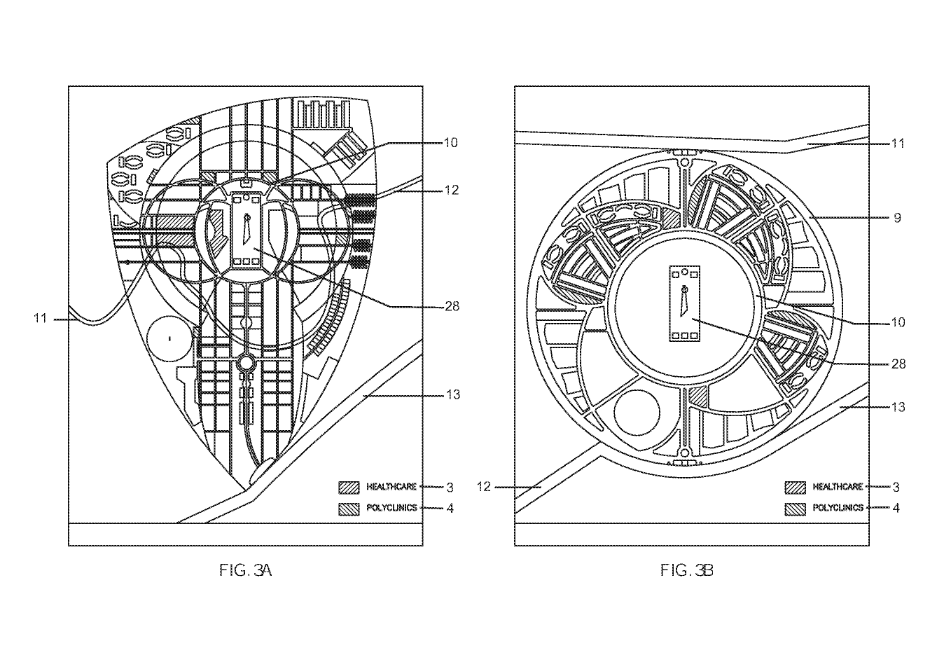

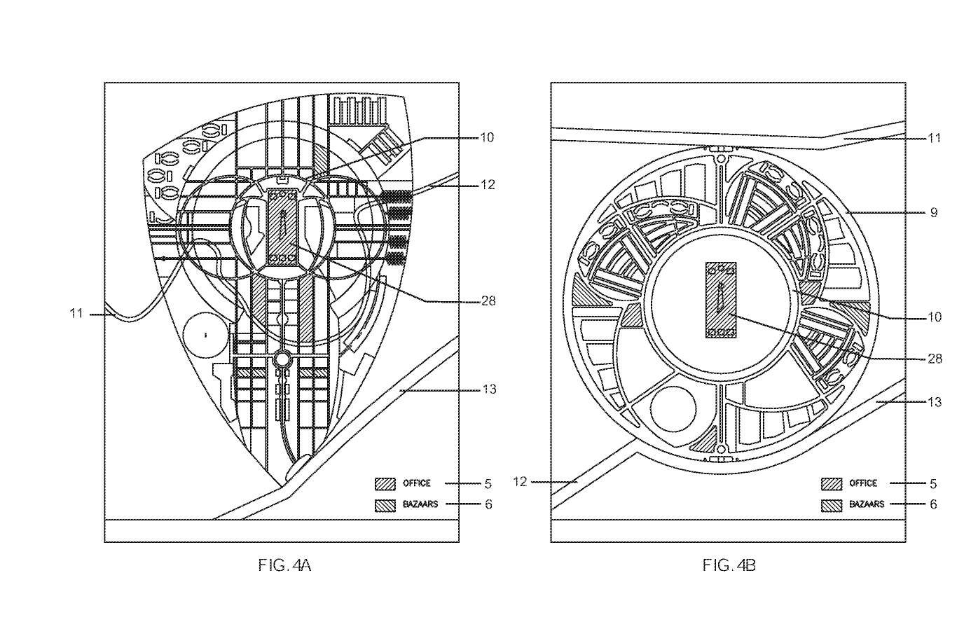

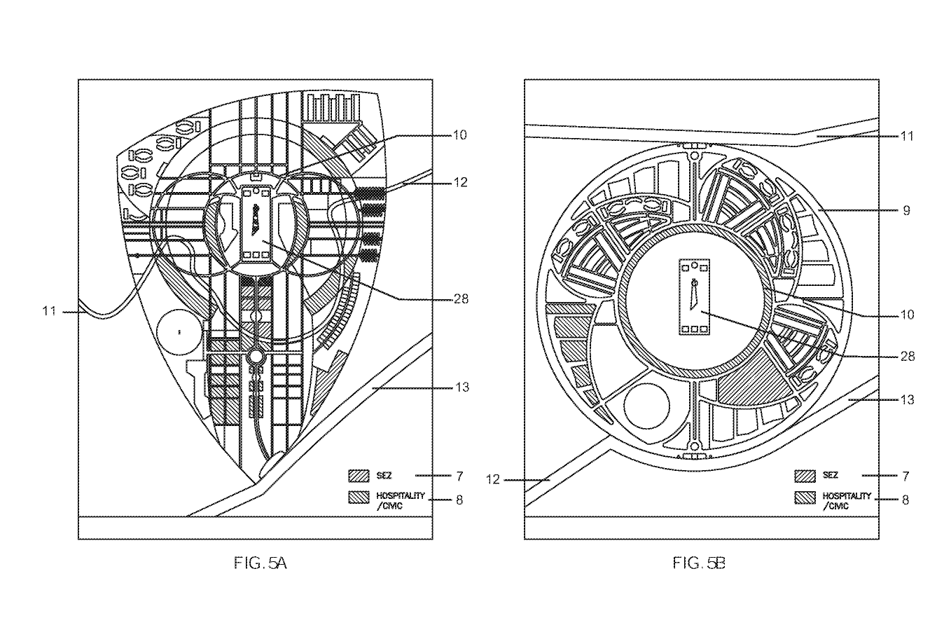

The present invention has application to a variety of commercial endeavours. In one embodiment, an occupiable space is created as stand-alone habitable buildings for use as apartment, lodging, private home, theatre, restaurant, financial, healthcare, business establishment, recreation area, educational, recreational or worship zone or any other use allowed under the local land development ordinances. In various other embodiments, each sport theme layout includes a plurality of buildings to provide educational, recreational, entertainment, worship or commercial amenities or a combination thereof built as part of an overall community development plan such as the community of FIG. 1, thereby designing a layout with the physical plan which attempts to organize the different zones as depicted in FIG. 2-5, in a order that they are closer, safer, quieter, cleaner and smarter.

The master plan aims at achieving neighborhoods which are more livable, sustainable, innovative and integrated. It is designed in such a way that it can be developed in phases, and each phase is self sufficient. The plurality of buildings in the layout has distinct visual appearance and each of the plurality of buildings is distinct from each other. At the same time the layout gives sufficient variations in occurrences of the sport to accommodate and depict various events of the sport. When the layout is viewed from the top view, it would depict a sports stadium where that particular sport or game is being played at a given point in time.

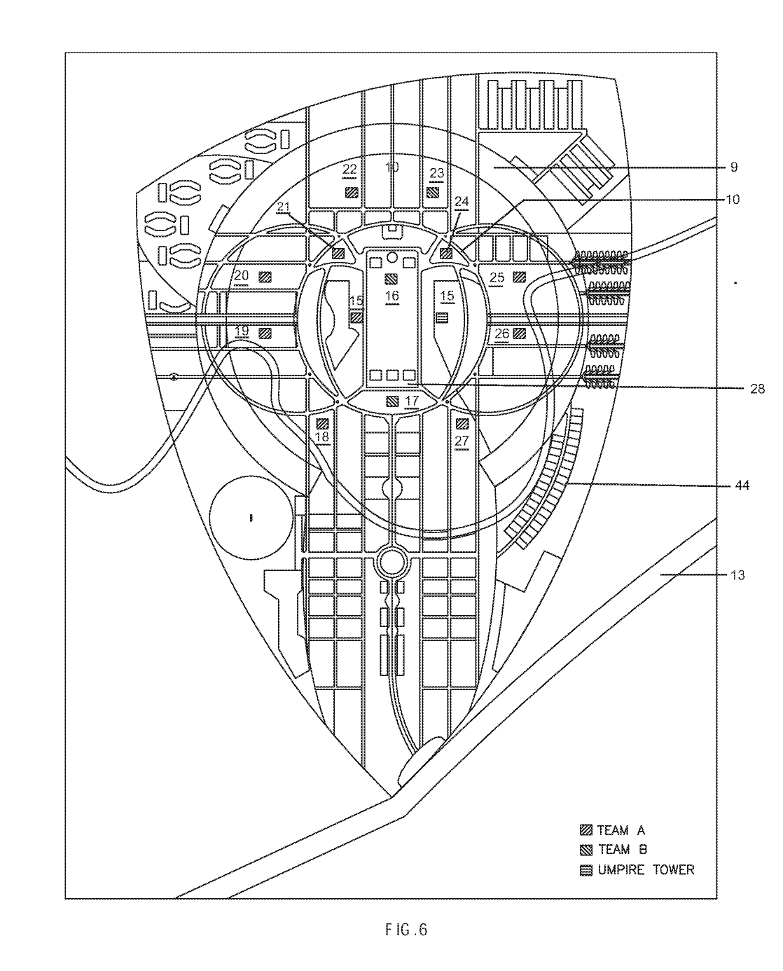

A cricket game based layout as shown in FIG. 6 is an exemplary layout resembling a cricket stadium encompassing the cricket field and all features of the game. The layout is structured into specific areas primarily for positioning various aspects of the game, namely the players at strategic positions, pitch, equipment, markings etc.

The game of cricket is a bat and ball game played between two teams of 11 players per side in a cricket stadium, where the teams take turns to bat and field (bowl). The game is played on a roughly circular field, at the center of which is a rectangular batting pitch. The field is divided into two areas called the inner field and the outer field. The two sets of three wooden stumps with two bails on the top are the wickets. There will be a total of 13 players in the field during the active part of the game, along with umpires. The two batsmen stand at the opposite ends of the pitch at each wicket with the bat. Out of the eleven players of the bowling team, two players take positions as bowler and wicket keeper and the other nine fielding players can take any of the strategic 19 field positions.

The FIG. 6 shows a cricket based layout, where in the estate is partitioned into multiple areas with connected roads resembling the game of cricket. The structures of the buildings in the multiple areas of the layout resemble various features of the game of cricket. The near circular inner 10 and near circular outer ring 9 roads in the layout depict the cricket field, showing the boundary line and the inner circle. These roads can be of multiple shapes to provide connectivity to various areas in the layout.

The layout comprises of buildings resembling a wickets shaped building 14 which can be triple circular buildings with a twin-bridge shaped structure on the top, to resemble the shape of wickets. The circular buildings need not be disjointed. The pitch 28 in the layout may comprise of a ball shaped structure or building and or a bat shaped structure or building 29 or can be an open area left for recreation purpose (park, swimming pool, sport area etc). The central pitch, iconic wicket towers & the bat tower, act as the downtown or the central business district.

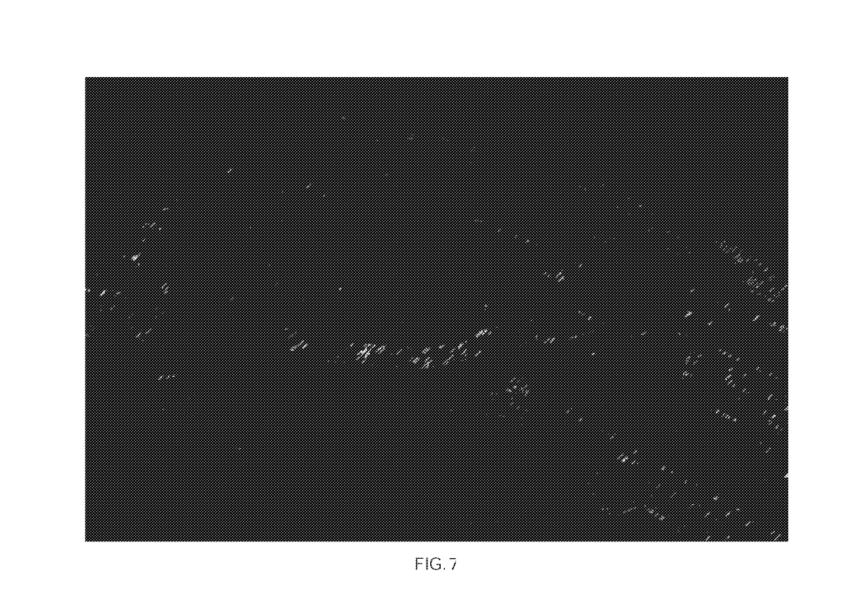

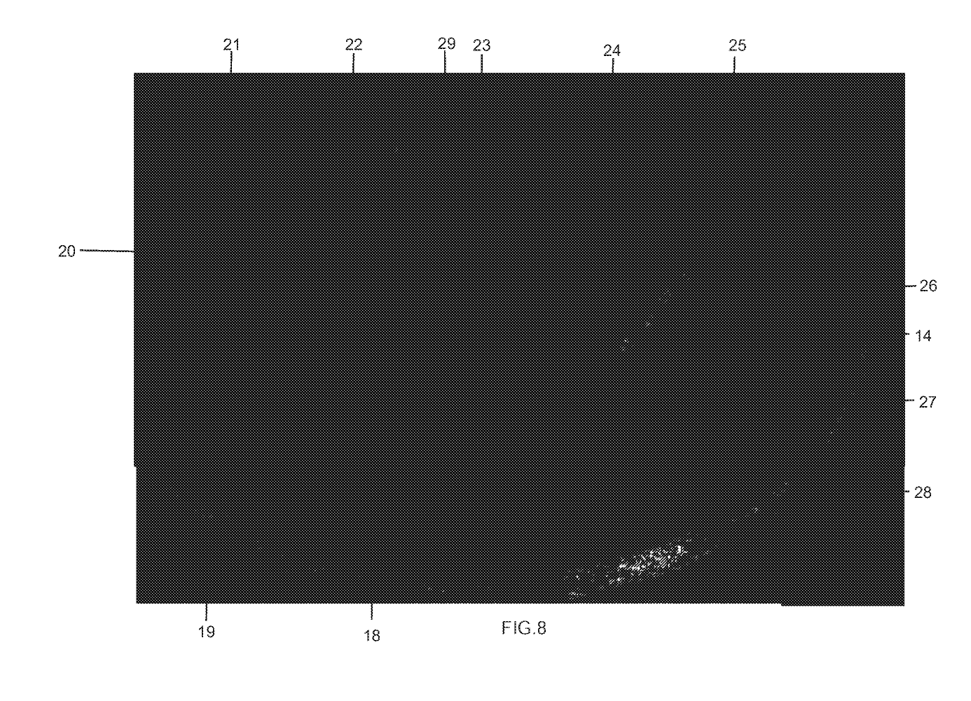

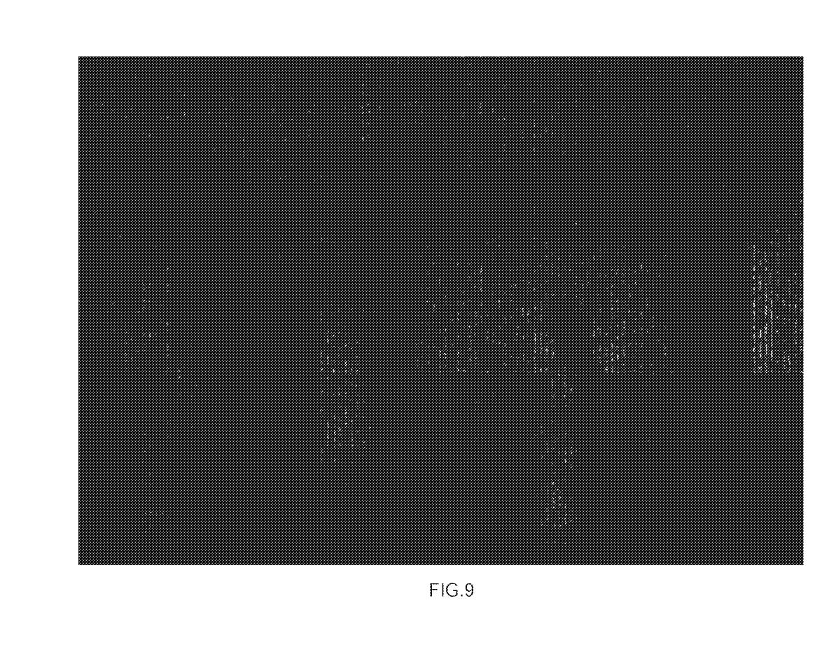

As can be seen from FIG. 6, the central game zone in the layout comprises of a plurality of buildings representing the players which are the batsman 16 on the batting side, bowler 17 and fielders 18-27 along with the umpires 15. The number of buildings and their positions can vary according to the size of the layout and can represent the various positions on the players of the bowling team on the cricket filed. The buildings can be positioned depicting the bowling side and can be positioned at for example keeper, slips, first slip, second slip, third slip, gully, point, cover, mid-off, mid-on, mid-wicket, square, square-leg, fine-leg, third-man, long-on, long-off, long-stop, straight, sweeper, long-leg, silly, backward, deep, deep-backward, deep-forward, deep-cover, deep-extra-cover, wide, leg-slip, leg-gully, cow-corner, infield, outfield). The layout also comprises plurality of areas comprising of spectator area with a plurality of buildings for open roof residential and or commercial spaces as depicted in various zones in FIGS. 2-5. The number of these buildings also can vary in number according the availability of the land for the layout. The plurality of areas in the layout comprise of various zones which be used for providing various amenities in the layout (museum, shopping, hospitals, schools, food courts, amusement areas, theatres etc). These different zones in the city forms the podium which is divided in to pockets which has a distribution of all the necessary zones within walking distance and the city's perimeter is defined by a clear edge, from which the city center can be reached on foot. An extended recreation system connects the pedestrian network to trails that run through the green buffer. The infrastructure and public-realm networks include electric shuttles, plazas, parks and links to the recreation system. As a primarily pedestrian city, only half of the road area is allocated to motorized vehicles and the layout can comprise of multiple ingress and egress paths 11-13 also providing various modes to connect the different areas in the layout. FIG. 7 depicts a 3D top view of the central cricket theme based layout. FIGS. 8 and 9 depicts the perspective top and side views of the buildings based on a cricket theme based layout.

The game based layout of the present invention can be developed depending on the land availability and the dimensions of the available land, as depicted as a master plan layout with different field dimensions in FIG. 1. The various zones which be used for providing various amenities in the layout (museum, shopping, hospitals, schools, food courts, amusement areas, theatres etc) can be developed in accordance with the available land as shown in FIGS. 2-5. The central game area can be varied according to the game of interest of the constructor or the area in which the layout is developed and can be modified as per the requirement either with or without the neighboring zones as per the availability of the land and the requirements of the constructor.

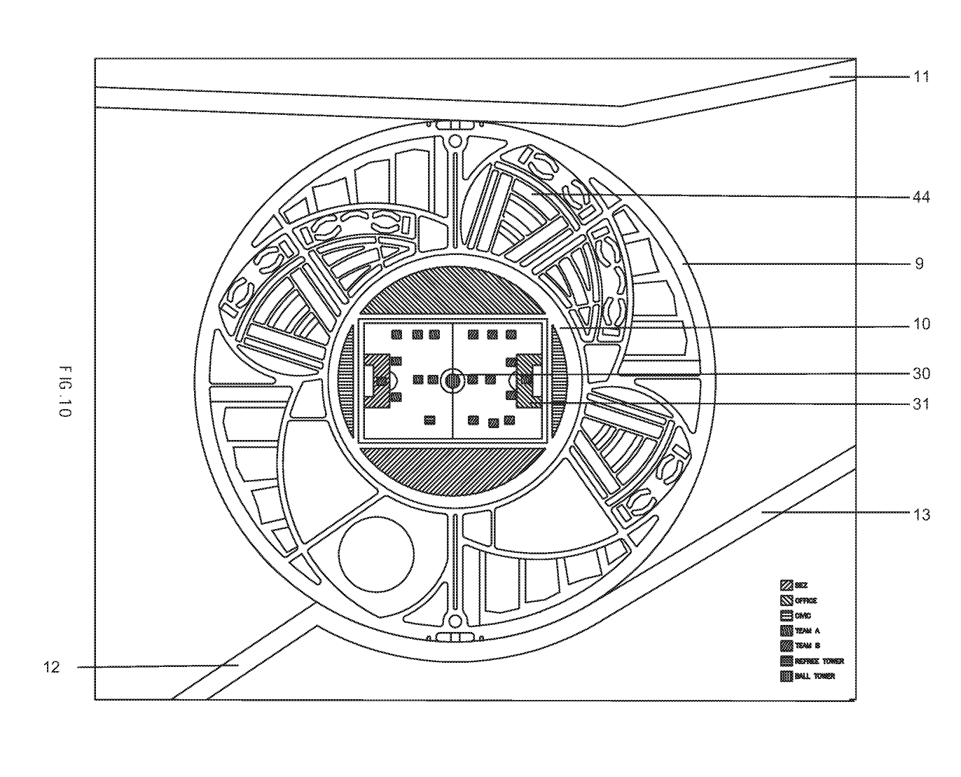

In another preferred embodiment of the present invention, the layout can be based on a soccer game as shown in FIG. 10, can be achieved by a plurality of buildings resembling a soccer ball 30, goal post 31, with a plurality of residential or commercial units resembling players in the central game zone of the layout. The soccer based layout may also comprise of a stadium based zone comprising of a plurality of zones 1-8 for providing various amenities for education, recreation, entertainment, museum, worship, commercial, shopping or a combination thereof.

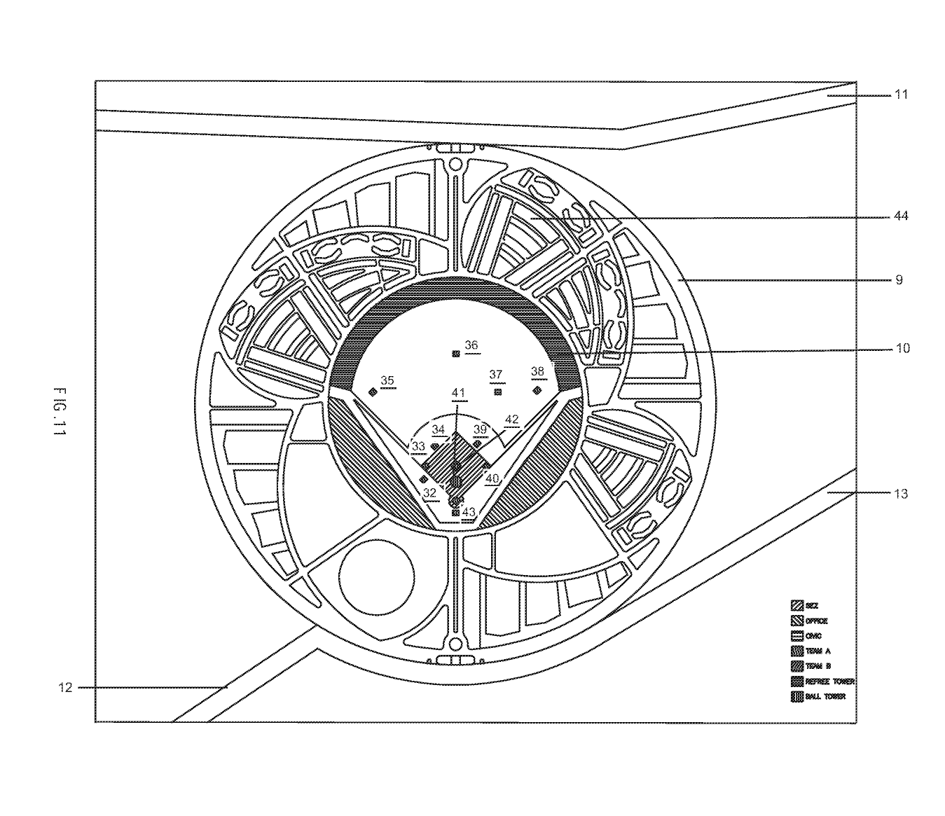

In another embodiment of the present invention, the layout can be based on a baseball game as shown in FIG. 11, depicts a typical layout of the central game zone of a sports theme based layout comprising a plurality of buildings resembling baseball 42, bat 41, players 32-40, a coach 43 and a plurality of residential or commercial units resembling a stadium seating 44 resembling more closely to a baseball stadium. This layout also comprises a plurality of zones 1-8 for providing multiple amenities for providing educational, recreational, entertainment, amusement park, museum, worship or prayer halls, community halls, commercial or office space, golf courses, sports academy amenities or a combination thereof.

As is well known, the type of event that can occur in a baseball game often depends upon the state of the inning. For example, with bases empty and nobody out, a batter may decide to try for a hit. However, if there is a runner on one of the bases, the batter may sacrifice in order to advance the runner. Furthermore, the events that occur may differ depending upon whether nobody is out or whether there are already two outs in the inning. The present layout accommodates for all these variations by altering the theme according to the event or having the players depicting an historical moment of the baseball game to relive the moments.

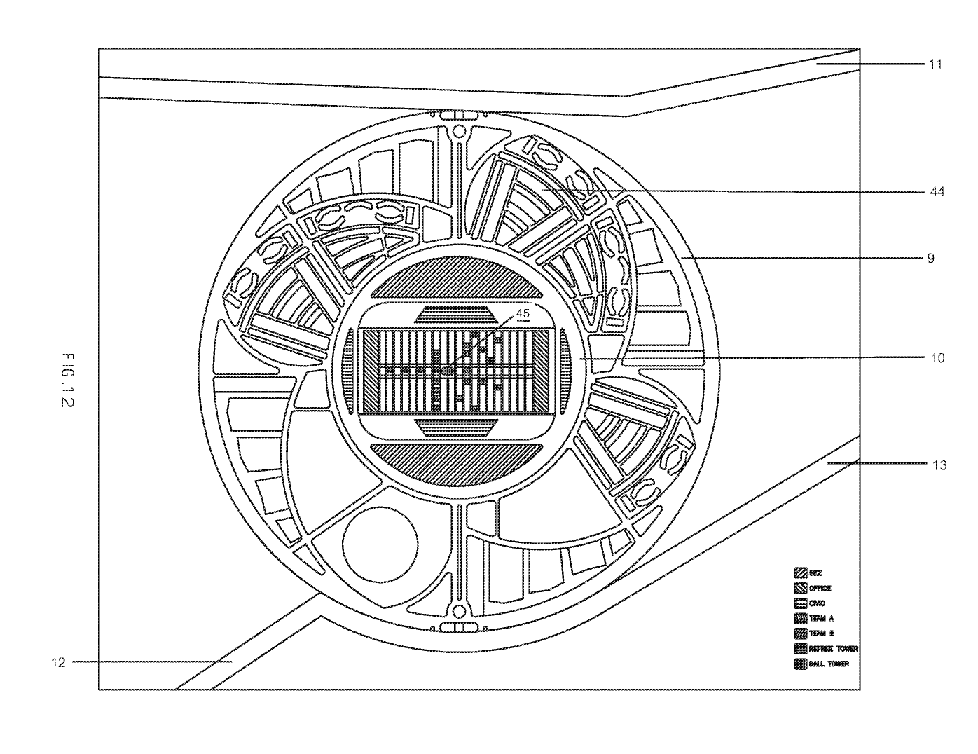

In yet another embodiment of the present invention, an American Football game based layout as shown in FIG. 12, can be achieved by a plurality of buildings resembling a football 45, players 46-57 as the central game zone area, with a plurality of residential or commercial units resembling a stadium seating 44. This layout may also comprise of a plurality of zones 1-8 for providing various amenities for education, recreation, entertainment, museum, worship, commercial, shopping or a combination thereof.

The fact that the layout can be provided in many different forms with alterations in the positions of the plurality of buildings underlying features of American football should be remembered.

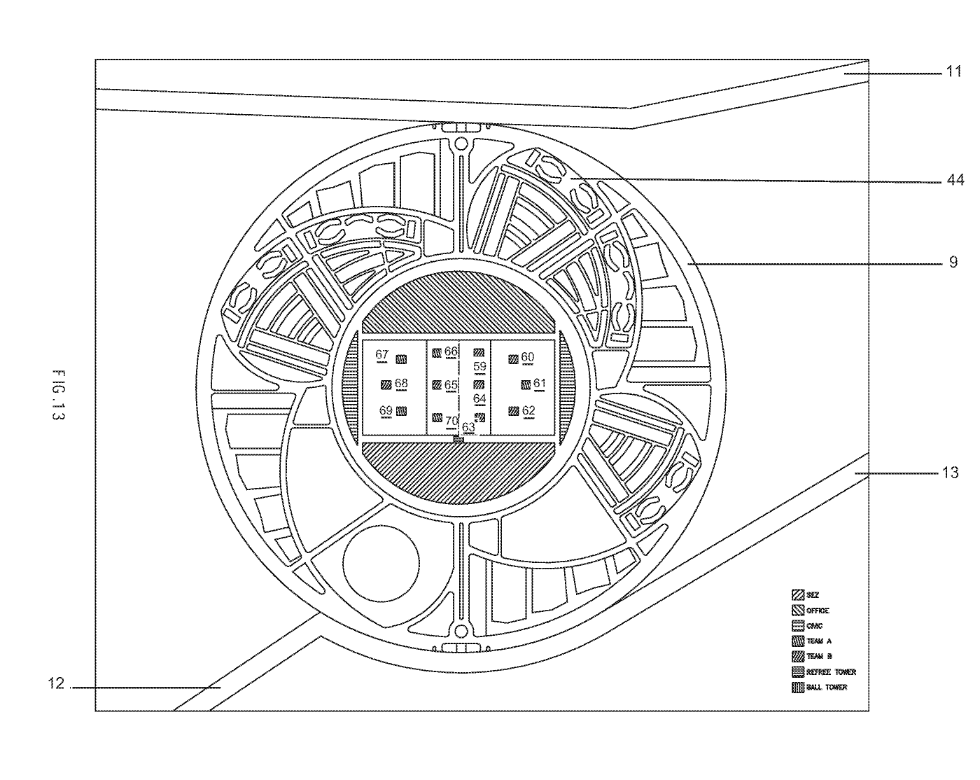

In another embodiment of the present invention, a layout based on volley ball as shown in FIG. 13, wherein the central game zone depicts a typical layout resembling a net based game and the plurality of building resembling the equipment such as a net based building 58, involved in the life-cycle of a volley ball game and the players 59-70. This layout thereby describes a net based sport usually played between two teams comprising of singles or multiple players on each side. A player on one of the teams begins a ‘rally’ by serving the ball (tossing or releasing it and then hitting it with a hand or arm), from behind the back boundary line of the court, over the net, and into the receiving team's court while the receiving team must not let the ball be grounded within their court.

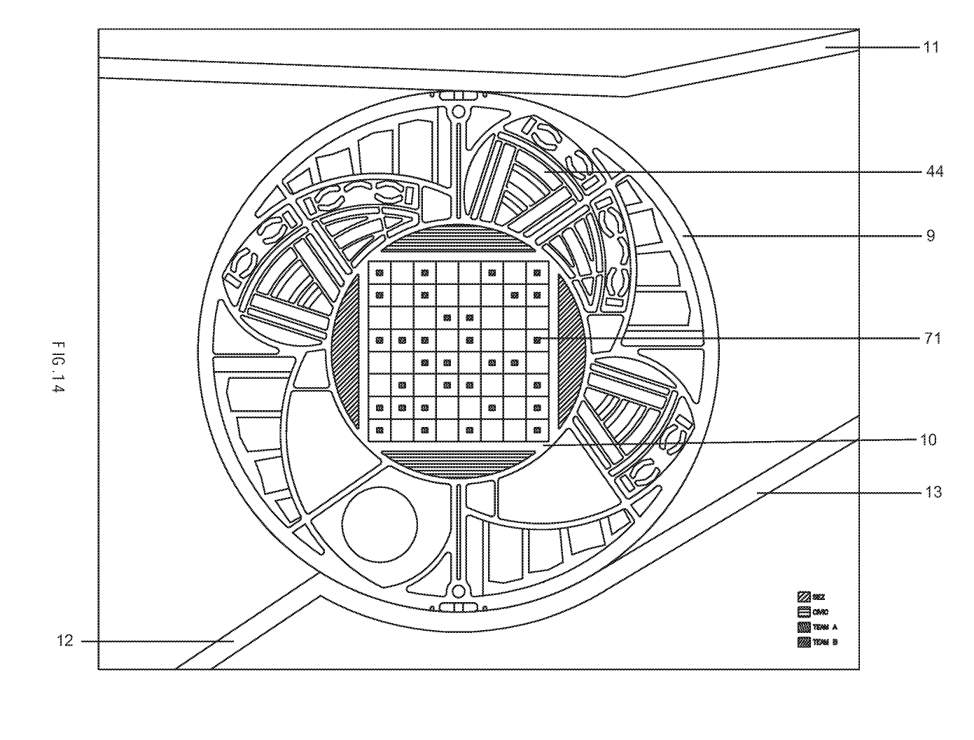

In yet another embodiment of the present invention a layout based on a chess game as shown in FIG. 14, wherein the central game zone depicts a typical layout resembling more closely to a chess game and the plurality of buildings resembling chess pieces 71 and a plurality of residential or commercial units resembling a stadium seating 7. This layout also comprises a plurality of zones 1-8 for providing multiple amenities for providing educational, recreational, healthcare, financial, entertainment, amusement park, museum, worship or prayer halls, community halls, commercial or office space, golf courses, sports academy amenities or a combination thereof.

A chess game based layout comprises of a plurality of square lands with plurality of buildings which can be anywhere between 2 to 32 and the architect may customize the number the buildings and their positions depicting the chess pieces according to the availability of the land area or any other parameters or for representing a historical winning position of the pieces in the game.

In various embodiments, the game based layout comprise of any number of buildings for resembling the game or sport along with various equipments and players with the field positions of the sport, referees, spectators related to the lifecycle of a specific sport or a combination of sports. The amusement park and the museum area are specifically designated to promote, educate and entertain people utilizing the master plan or visitors to enable the promotion of the sport. The history of the sport is also preserved in the museum to ensure future generations would be able to learn and evolve.

Accordingly, a method used to design a layout that is based on a sports theme by identifying one or more local sport which is more popular in the region the layout is developed in that are important for the recreation of the fantasy of living out a sport.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A method of and designing a layout comprising:
selecting a single or multiple sports for a theme based layout;
identifying and designing a plurality of zones, buildings in the layout;
arranging the said plurality of zones and buildings in the layout with multiple ingress and egress paths to the layout and multiple forms for distribution of the spaces between the said plurality of architectural elements.

2. The method of claim 1, wherein the step of designing a plurality of architectural elements comprises designing the buildings to incorporate an exterior façade of various equipments and individuals related to the lifecycle of a sport selected.

3. A sports theme based layout comprising of central game zone based on a sports theme and surrounding area based on a stadium theme, comprising of single or multiple occupiable spaces with a plurality of buildings for providing either one or simultaneously residential, commercial, educational and other essential amenities.

4. The sports theme based layout of claim 3 comprising of a central game zone based on a sport or a game.

5. The central game zone of a sports theme based layout of claim 4 having a plurality of buildings resembling various equipments and individuals related to the lifecycle of a sport.

6. The sports theme based layout of claim 3 comprising of buildings and habitable structures which resemble various equipment or individuals related to the lifecycle of a sport selected.

7. The sport theme based layout of claim 4 wherein the central game zone would resemble cricket, hockey, baseball, American football, soccer, volley ball, chess, or any other such sport or a combination of sports.

8. The central game zone of a sports theme based layout of claim 4 wherein the central game zone is based on bat and ball based game.

9. The bat and ball game of claim 8 of the central game zone in a sports theme based can be selected from cricket, hockey, base ball and other such games.

10. The plurality of buildings of claim 9 wherein the layout is based on a cricket theme comprises of a single or plurality of buildings, each said building resembling
a bat;
a player;
an umpire;
a wicket;
a ball;
an area representing a cricket pitch on the said cricket field in the layout;
the plurality of player buildings dispersed in various positions representing two opposing teams;

11. The central game zone of a sports theme based layout of claim 4 wherein the central game zone is based on net based games.

12. The buildings of the net based sport theme layout of claim 11 wherein the layout is based on a volley ball game theme comprising of a single or plurality of buildings; each said building resembling
a player;
a volley ball
a net

13. The central game zone of a sports theme based layout of claim 4 wherein the central game zone is based on a ball based games.

14. The buildings of a ball based sports theme layout of claim 13, wherein the layout is based on a soccer theme comprising of a plurality of buildings; each said building resembling
a soccer ball;
a player;
a goal post;
a referee

15. The central game zone of a sports theme based layout of claim 4 wherein the central game zone is a board based games.

16. The buildings of a board based sport theme layout of claim 15, wherein the layout is based on a chess game comprising of a plurality of buildings; each said building resembling the chess pieces.

17. The buildings of claim 5 wherein the layout is based on a chess theme, the plurality of buildings resemble the chess pieces.

18. The layout of claim 1 comprising a plurality of zones in the game zone and stadium zone for providing either or all amenities for residential, educational, recreational, entertainment, worship and commercial.

19. A method for planning and designing a layout to generate a sports theme based layout, types of occupiable space and the form and distribution of the spaces between the plurality of buildings.

20. The method for planning and designing a layout as described in claim 19 which is a sport or game theme based layout.

21. A method to “live out a sport”™ by providing a plurality of buildings which are replicated to resemble various equipments and individuals related to the lifecycle of a sport.

22. The method of claim 21 comprising a plurality of buildings for simultaneously providing residential, educational, recreational, entertainment, worship or commercial amenities or a combination thereof.

23. A method of promoting a sport by constructing a sport theme based layout for sale or give-away to promote the sport; the layout comprising of a plurality of buildings constructed to resemble various equipments, players related to the lifecycle of a specific sport or a combination of sports.

24. The sports theme based layout of claim 23 comprising of various zones, buildings constructed to resemble various equipment of a sport or individuals, a central game zone depicting the area for the sport with the plurality of buildings, a stadium theme based zone comprising of various buildings which be used for providing various amenities in the layout.

25. The various zones of the sports theme based layout of claim 24 can be selected from hospitality, residential, financial, healthcare, polyclinic, offices, civic or a combination thereof.

26. The various amenities of the sports theme based layout of claim 24 can be selected from museum, restaurants, shopping, hospitals, schools, food courts, amusement areas, religious, theatres civic or a combination thereof.
